(19) United States
(12) Patent Application Publication
(10) Pub. No.: US 2019/0044395 A1
(43) Pub. Date: Feb. 7, 2019

(54) ELECTRIC MACHINE

(71) Applicant: Jaguar Land Rover Limited, Whitley, Coventry, Warwickshire (GB)

(72) Inventors: Istvan KIRALY, Whitley, Coventry (GB); Alexandros MICHAELIDES, Whitley, Coventry (GB); Jose SOLER, Whitley, Coventry (GB)

(21) Appl. No.: 16/074,048

(22) PCT Filed: Jan. 30, 2017
(86) PCT No.: PCT/EP2017/051939

§ 371 Date: Jul. 30, 2018

(30) Foreign Application Priority Data
Feb. 15, 2016 (GB) 1602629.6

(51) Int. Cl. H02K 1/14

(52) U.S. Cl. CPC H02K 1/141; H02K 41/031; H02K 1/146

(57) ABSTRACT

The present disclosure relates to an electric machine (1) having a rotor (5) and a stator (4). The rotor (5) has a plurality of rotor poles (12). The stator (4) is part-annular and has a plurality of stator teeth (9) each having a winding. The stator (4) includes a plurality of sets (S1-9) of said stator teeth (9), each set (S1-9) comprising more than one stator tooth (9). The sets (S1-9) are magnetically de-coupled from each other. The windings (11) on the stator teeth (9) in each set (S1-9) are in different phases (A, B, C). The present disclosure also relates to a vehicle (2) having an electric machine (1) of the type described herein.

### TECHNICAL FIELD

The present disclosure relates to an electric machine. More particularly, but not exclusively, the present disclosure relates to an electric machine for use in a vehicle. The present disclosure also relates to a vehicle including an electric machine.

### BACKGROUND

It is known to provide an electric machine in a vehicle to generate a tractive force for propelling the vehicle. The electric machine typically includes a stator and a rotor. The electric machine may be the sole means of propulsion for the vehicle, or may be used in conjunction with another torque generating machine, such as an internal combustion engine. In certain applications there may be constraints on the available packaging space for the electric machine. It may not be possible for the stator to have a complete annular configuration (i.e. extending through 360°). However it is desirable to use the maximum available rotor diameter to develop the maximum torque. One possible application where packaging limitations may arise is a hybrid electric vehicle in which the electric machine may be disposed in a housing of a transmission coupled to an internal combustion engine. In this application, external devices may impinge on to the transmission housing, thereby reducing the available volume in the transmission housing to accommodate the electric machine.

It is known from the applicant's earlier applications PCT/EP2013/074280 and GB1303653.8 to provide an electric machine having a stator formed from a plurality of segments. The segments may be configured to form a part-annular stator.

At least in certain embodiments, the present invention seeks to provide an electric machine which overcomes some of the shortcomings of known electric machines.

### SUMMARY OF THE INVENTION

Aspects of the present invention relate to an electric machine; and to a vehicle as claimed in the appended claims.

According to a further aspect of the present invention there is provided an electric machine comprising:
a rotor having a plurality of rotor poles; and
a part-annular stator having a plurality of stator teeth each having a winding;
the stator comprising a plurality of sets of said stator teeth, each set comprising more than one stator tooth and the sets being magnetically de-coupled from each other;
wherein the windings on the stator teeth in each set are in different phases. The stator has a plurality of windings which are out of phase with each other. In use, a poly-phase electrical current is supplied to the electrical machine to excite the windings. The winding topology of the stator is configured such that the windings in each set have a different phase. At least in certain embodiments, the windings on the stator teeth may be configured to reduce voltage harmonics which increase the peak value of the back electromotive force (back-EMF) and may not produce a useful torque component. The magnetic de-coupling of the sets of stator teeth may also reduce voltage imbalances in the electric machine.

The electric machine is a poly-phase electric machine. Alternatively, the electric machine may be a three-phase electric machine and the sets may each consist of two stator teeth. In use, a three-phase electrical current may be supplied to the electrical machine to excite the windings. The sets may each consist of a pair of said stator teeth. In other words, the sets may each consist of two stator teeth. The electric machine could be a six (double three)-phase electric machine and the sets may each consist of two stator teeth.

In certain embodiments, the stator may comprise eighteen (18) stator teeth. The winding topology of a three-phase electric machine having eighteen (18) stator teeth may be as follows:

−A−B+B+C−C−A+A+B−B−C+C+A−A−B+B+C−C−A.

It will be understood that different winding topologies can be implemented, for example for electric machines having different number of phases and/or different numbers of teeth.

The stator has a part-annular profile. Thus, the stator teeth are disposed around only a portion of the rotor. The stator may, for example, have a C-shaped profile, or may comprise two or more segments angularly separated from each other. The stator may comprise a part-annular section from which the stator teeth extend radially inwardly.

The stator may comprise a plurality of flux barriers to magnetically de-couple the sets from each other. The flux barriers may each comprise one or more hollow cavity formed in the stator. Alternatively, the flux barriers may comprise a material having electrical conductivity and magnetic permeability equivalent to the corresponding parameters in air. The flux barriers may be formed in the part-annular section of the stator. The flux barriers may be formed in the part-annular section between said stator teeth.

The stator may comprise a plurality of sub-sections which are magnetically de-coupled from each other. The sub-sections may each comprise at least one of said sets of stator teeth. In certain embodiments, each sub-section may consist of one set formed of two of said stator teeth.

The sub-sections may comprise more than one of said sets of stator teeth. For example, the sub-section may comprise two or more sets of stator teeth. The sets of stator teeth may each consist of two of said stator teeth. The sub-sections may each comprise one or more flux barrier configured to separate the sets of stator teeth. For example, one of said sub-sections may comprise four stator teeth which are separated into two equal sets by one or more flux barrier.

The rotor poles may each be formed by one or more permanent magnet.

According to a further aspect of the present invention there is provided an electric machine comprising:
a rotor having a plurality of rotor poles; and
a stator having a plurality of stator teeth each having a winding;
the stator comprising a plurality of sets of said stator teeth, each set comprising more than one stator tooth;
wherein the stator comprises a plurality of flux barriers to magnetically de-couple the sets from each other.

The flux barriers may comprise one or more hollow cavity formed in the stator.

The stator may comprise an outer section from which the stator teeth extend radially inwardly. The flux barriers may be formed in said outer section. The outer section may be annular or part-annular.

The windings on the stator teeth in each of said sets may be in a different phase.

The electric machine(s) described herein is a poly-phase electric machine. The electric machine could be a six-phase electric machine. The electric machine may be a three-phase electric machine. In use, a three-phase electrical current may be supplied to the electrical machine to excite the windings.

According to a further aspect of the present invention there is provided a vehicle comprising an electric machine as described herein. The electric machine may be a traction motor for generating a tractive force to propel the vehicle.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the present invention will now be described, by way of example only, with reference to the accompanying figures, in which:

FIG. 1 shows a schematic representation of a vehicle incorporating an electric machine in accordance with an embodiment of the present invention;

FIG. 2 shows a sectional view of the electric machine shown in FIG. 1;

FIG. 3 shows a first coil topology of the windings on the stator of the electric machine shown in FIG. 2;

FIG. 4 shows a sectional view of a variant of the electric machine shown in FIG. 2;

FIG. 5 shows a known second coil topology of the windings on the stator of an electric machine;

FIGS. 6A and 6B show the voltage characteristics of the electric machine incorporating the first and second coil topologies;

FIGS. 7A and 7B show the torque characteristics of the electric machine incorporating the first and second coil topologies; and

FIG. 8 shows a sectional view of a further variant of the electric machine shown in FIG. 2.

### DETAILED DESCRIPTION

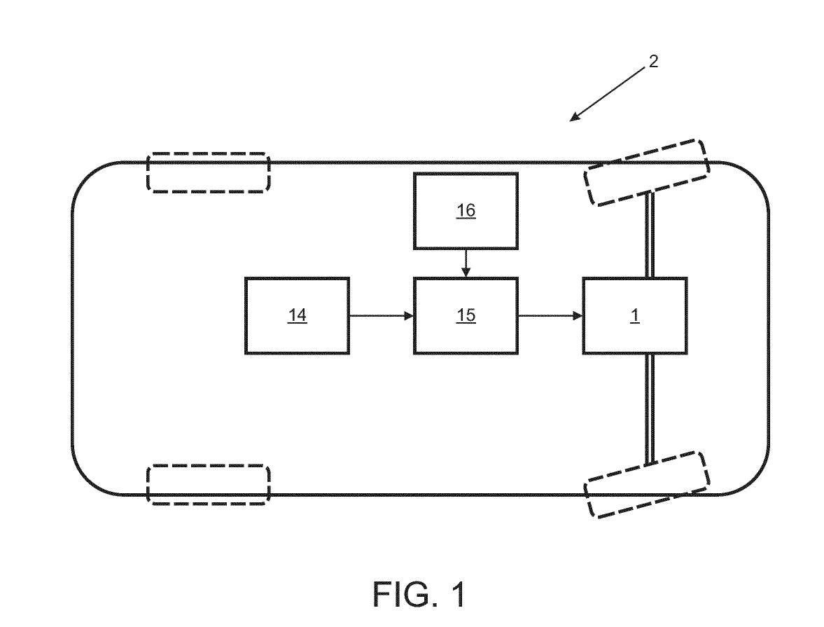

An electric machine 1 in accordance with embodiments of the present invention will now be described by way of example. As illustrated in FIG. 1, the electric machine 1 has particular application in a vehicle 2 to generate a traction force. The electric machine 1 can operate in the traction mode to provide the sole tractive force for propelling the vehicle, for example an electric vehicle (EV); or in conjunction with the internal combustion engine, for example a hybrid electric vehicle (HEV).

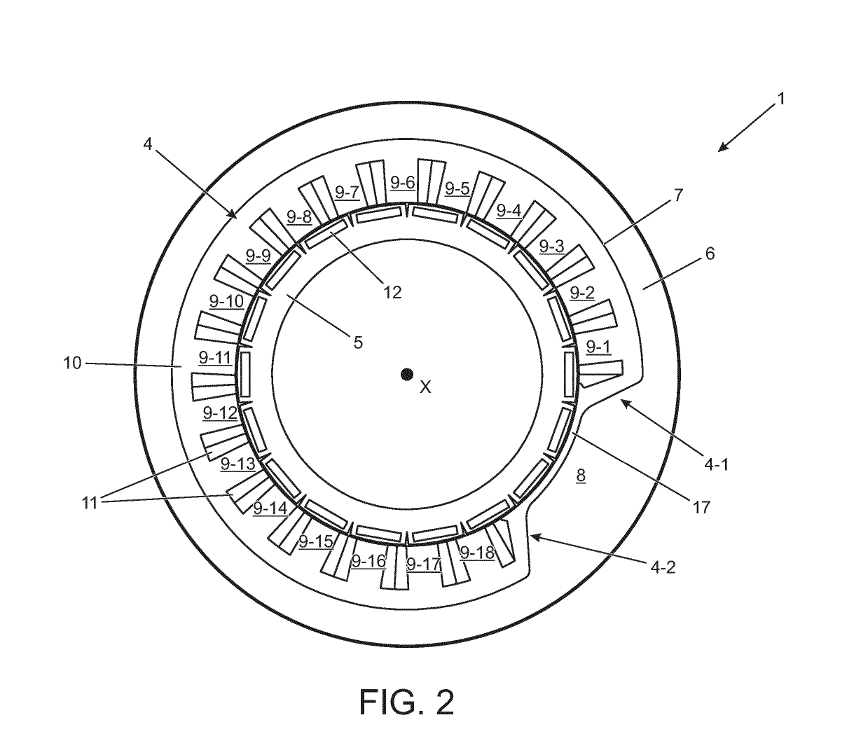

With reference to FIG. 2, the electric machine 1 is a permanent magnet synchronous motor (PMSM). The electric machine 1 is a three-phase machine in the present embodiment. The electric machine 1 comprises a stator 4 and a rotor 5. The rotor 5 is configured to rotate about a longitudinal axis X of the electric machine 1 (extending perpendicular to the plane of the page on FIG. 2). The electric machine 1 is described herein with reference to a transverse cross-section disposed perpendicular to said longitudinal axis X.

The electric machine 1 is installed within a component housing 6, such as a transmission housing, of the vehicle 2. The component housing 6 defines a chamber 7 for the electric machine 1. A protuberance 8 projects inwardly into the chamber 7. The remainder of the chamber 7 has a circular profile in transverse cross-section. The protuberance 8 can, for example, be formed by one or more assembly or machine, such as a power transfer unit or a starter motor, which may be disposed within the chamber 7 or adjacent to the component housing 6.

The stator 4 has a part-annular profile in transverse cross-section. Specifically, the stator 4 consists of a major annular sector in transverse cross-section. The corresponding minor annular sector is an annular gap formed in the stator 4 to accommodate the protuberance 8. Thus, in transverse cross-section, the stator 4 is generally C-shaped and comprises first and second ends 4-1, 4-2 which are separated from each other. As described herein, the angular extent of the major and minor annular sectors is defined to accommodate the protuberance 8. The stator 4 is formed from a plurality of laminations arranged in face-to-face contact with each other to form a stacked core. The laminations can, for example, be made of electrical steel.

The stator 4 comprises a plurality of stator teeth 9 projecting radially inwardly from a radially outer part-annular segment 10. The stator 4 in the present embodiment extends over 300° and comprises eighteen (18) stator teeth 9. The stator teeth 9 are labelled 9-1 through 9-18 in a counter-clockwise direction starting from the first end 4-1 of the stator 4. The stator teeth 9 have an angular spacing of 16.67°. Unlike fully swept electric machines (i.e. electric machines having a stator extending over 360°), the angle between the stator teeth 9 is not an integer multiple of 360°. The stator 4 can be formed from one or more segments provided the resulting flux paths are self-contained within each segment. The number of stator teeth 9 in each segment may, for example, be eighteen (18), nine (9), six (6) or two (2). It will be appreciated, therefore, that the stator 4 may have a modular design. The dimensions of each segment can be modified to reduce torque ripple and voltage harmonics.

The rotor 5 has a substantially circular transverse cross-section and is arranged coaxially with the stator 4. The rotor 5 comprises eighteen (18) permanent magnets which form rotor poles 12 having uniform angular spacing around the rotor 5. Thus, the rotor pole pitch is 20° in the present embodiment. The rotor poles 12 are each formed by one or more permanent magnets. The rotor poles 12 can, for example, be made of rare-earth materials to provide a high density of magnetic flux.

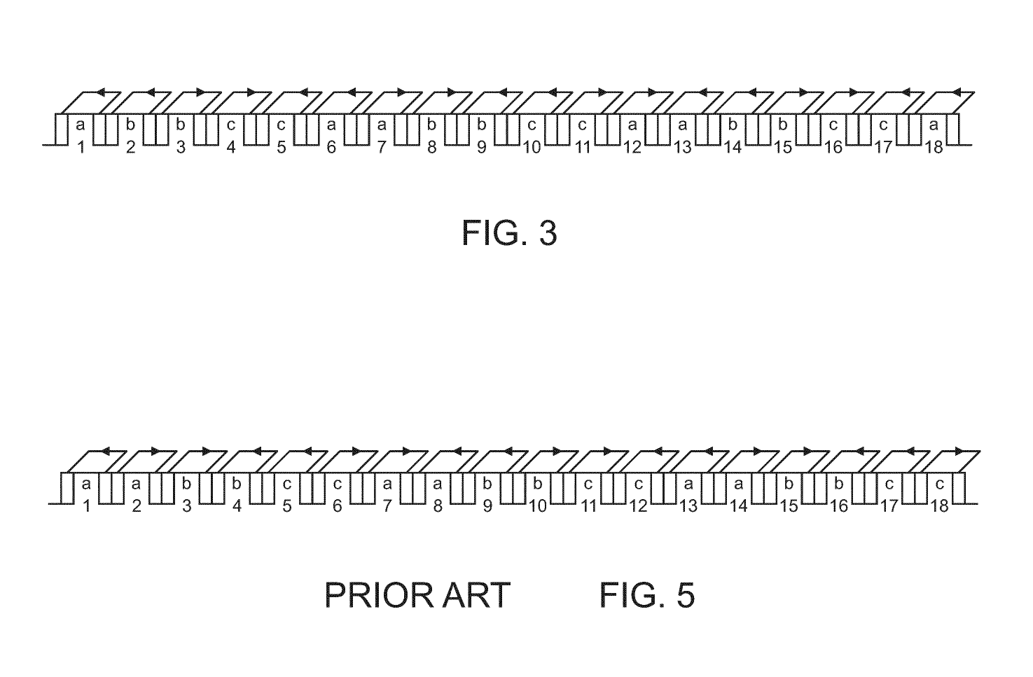

The stator teeth 9 carry windings 11 connected to the 3-phase supply. In the present embodiment the windings 11 are concentrated windings comprising separate coils wound on each stator tooth 9. The phase shift between the windings 11 is 150 electrical degrees. If the windings 11 of two adjacent slots are in the same phase, then these windings 11 are connected with opposite polarity, resulting in a phase shift of 30 electrical degrees. At least in certain embodiments this can enable a higher torque density and/or a lower current density. With reference to FIG. 3, the first coil topology [T1] of the windings 11 is as follows:

−A−B+B+C−C−A+A+B−B−C+C+A−A−B+B+C−C−A [T1]

It will be understood that the first coil topology [T1] defines the phase of the current supplied to the stator teeth 9-1 to 9-18 in a counter-clockwise direction starting from the first end 4-1 of the stator 4. With reference to FIG. 1, the windings 11 are electrically coupled to a high voltage (HV) battery 14 via a first inverter 15. A control unit 16 comprising a first electronic controller (not shown) is provided for sequencing the supply of current to the windings 11. The interaction of the current in the windings 11 and the magnetic flux generated by the permanent magnets in the rotor poles 12 cause the rotor 5 to rotate. The supply sequence is the same as a conventional three (3) phase PMSM having a circular stator. Thus, the electric machine 1 operates in a conventional manner.

With reference to FIG. 2, a circumferential shield element 17 extends between the ends of the stator 4 to reduce the transmittal of magnetic flux from the rotor poles 12 into the component housing 6. However, the first and second ends 4-1, 4-2 of the stator 4 are magnetically isolated and this can result in voltage imbalances within the electric machine 1.

At least in certain embodiments the configuration of the stator 4 helps to reduce the volume of the stator teeth 9 and to lower the back-EMF harmonic content (compared to an equivalent 3/2 topology). The stator 4 may also lower the motor frequency by up to 10% (compared to a known fractional slot topology); and reduce the voltage imbalance in back-EMF of the windings 11 belonging to the same phase (compared to an equivalent 3/2 topology).

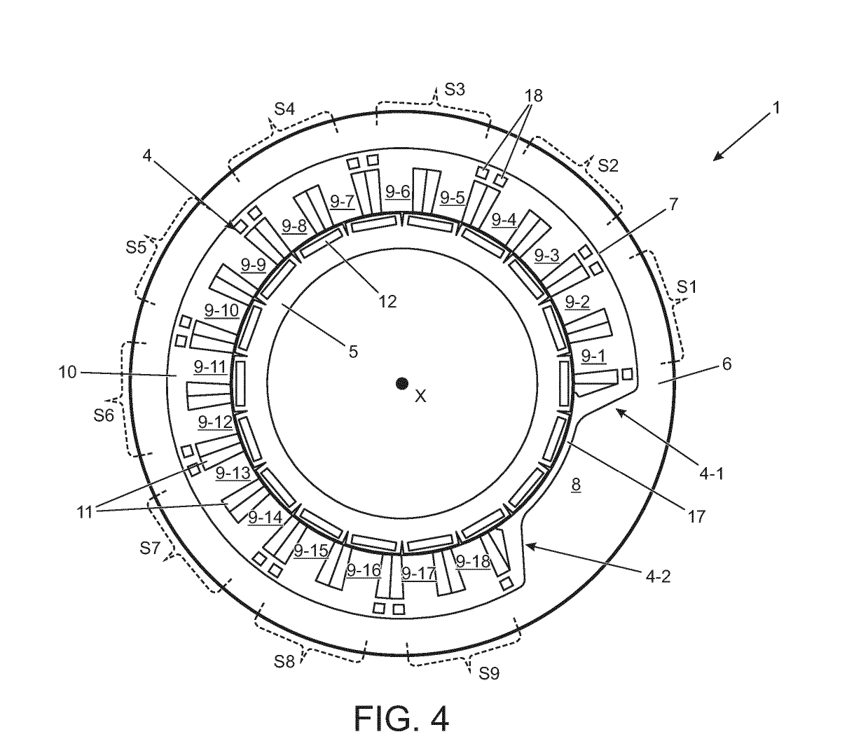

A variant of the stator 4 is shown in FIG. 4. Like reference numerals are used for like components. The configuration of the stator teeth 9 is unchanged from the configuration described with reference to FIG. 3. In particular, the stator 4 extends over 300° and comprises eighteen (19) stator teeth 9. The angular spacing of the stator teeth 9 is 16.67°. Furthermore, the first coil topology [T1] is unchanged for the stator teeth 9.

As shown in FIG. 4, the stator 4 comprises a plurality of flux barriers 18 which sub-divide the stator 4 into a plurality of sets (S1-9) of said stator teeth 9. The flux barriers 18 control the flux density within the stator 4 by reducing the magnetic coupling between the stator teeth 9 in each set (S1-9). In certain embodiments, the flux barriers 18 may be decouple the stator teeth 9 in each set (S1-9). The reduced magnetic coupling of the stator teeth 9 may reduce voltage imbalances in the electric machine 1. The flux barriers 18 are arranged such that each set (s1-9) consists of two (2) stator teeth 9. The flux barriers 18 in the present embodiment are in the form of hollow cavities formed in the radially outer part-annular segment 10 of the stator 4. The hollow cavities are formed in each lamination of the stator 4 such that the flux barriers 18 extend parallel to the longitudinal axis X of the electric machine 1. Two of said flux barriers 18 are formed between the stator teeth 9 in each set (S1-9). The flux barriers 18 may promote magnetic saturation within the radially outer part-annular segment 10 of the laminations of the stator 4. The localised magnetic saturation may promote magnetic isolation of each set (S1-9) of said stator teeth 9.

The stator teeth 9 carry windings 11 connected to the 3-phase supply. The windings 11 are concentrated windings comprising separate coils wound on each stator tooth 9. The first coil topology [T1] of the windings 11 is the same as detailed above and illustrated in FIG. 3. It will be understood that the windings 11 on the stator teeth 9 in each set (S1-9) are in different phases. This arrangement is significant since it may reduce the back-EMF of the electric machine 1. In particular, the first coil topology [T1] may be effective in reducing the 5th and 7th voltage harmonics. These harmonics do not produce a useful torque component, but do increase the peak value of back-EMF. It will be appreciated that the windings 11 may be selectively coupled to an electrical load and function as an alternator.

With reference to FIG. 5, a second coil topology [T2] is as follows:

−A+A+B−B−C+C+A−A−B+B+C−C−A+A+B−B−C+C [T2]

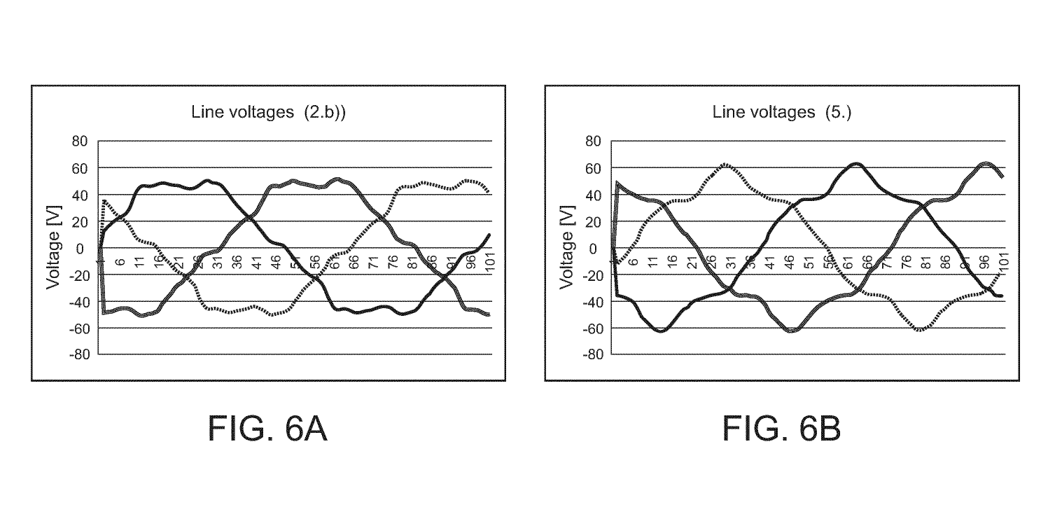

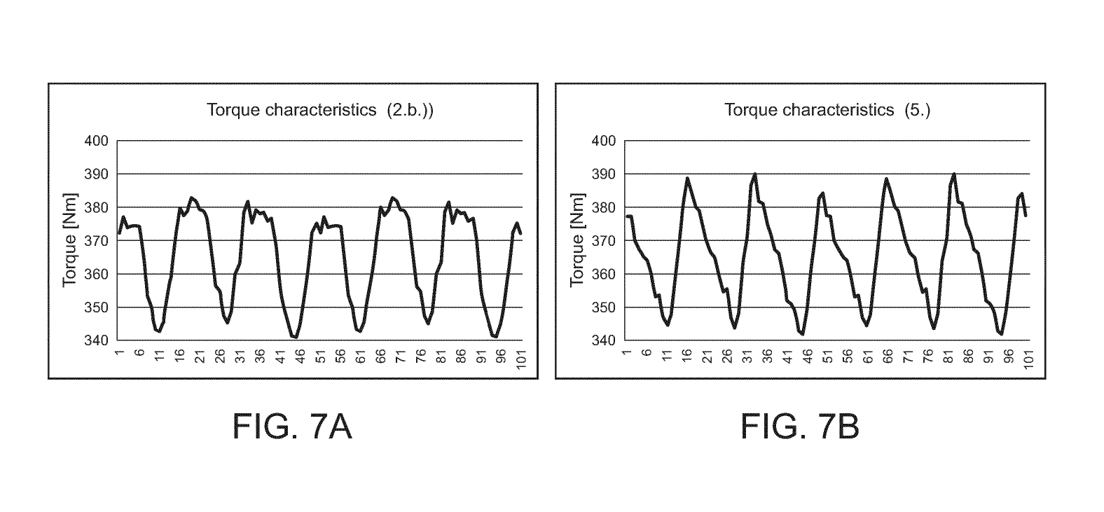

The second coil topology [T2] is a known coil topology. When the second coil topology [T2] is implemented on the electric machine 1, the stator teeth 9 in each set (S1-9) are in the same phase. A comparison was made of the operating characteristics of the electric machine 1 having the first coil topology [T1] and the second coil topology [T2]. The stator 4 of the electric machine 1 had the same number of laminations and the same number of turns per coil in each variation. The voltage characteristics for the first coil topology [T1] are shown in FIG. 6A; and the voltage characteristics for the second coil topology [T2] are shown in FIG. 6B. The first coil topology [T1] develops significantly lower line voltage than the second coil topology [T2]. In the present embodiment the line voltage in the first coil topology [T1] is approximately 51.3V; and the line voltage in the second coil topology [T2] is approximately 63V. The torque characteristics for the first coil topology [T1] are shown in FIG. 7A; and the torque characteristics for the second coil topology [T2] are shown in FIG. 7B. The first and second coil topologies [T1], [T2] develop approximately the same average torque, approximately 365 Nm in the present configuration, for the same configuration of the stator 4.

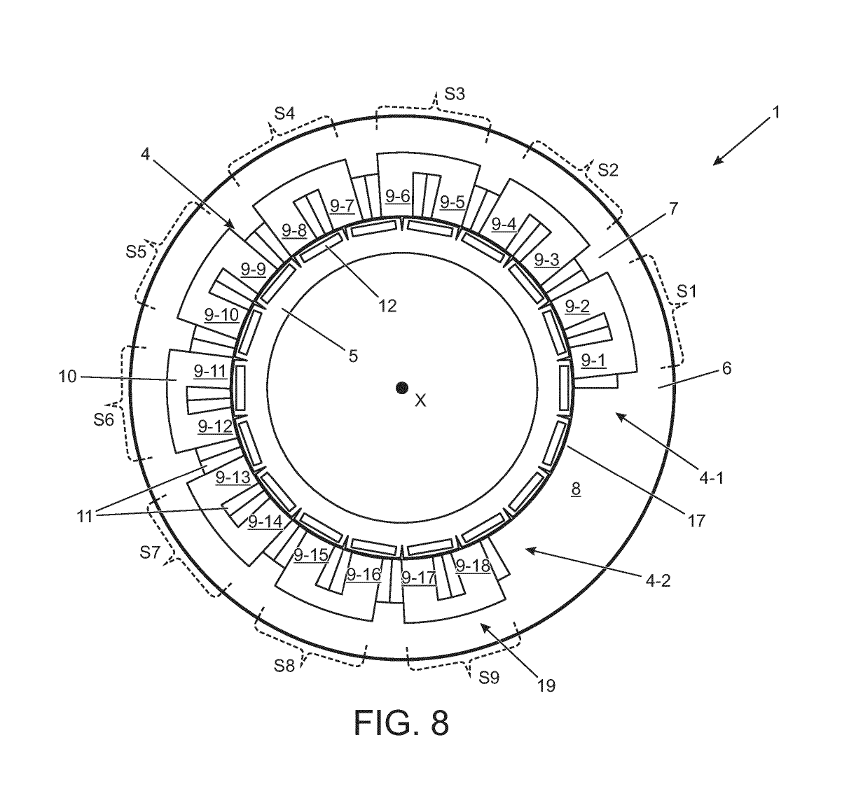

A variant of the stator 4 shown in FIG. 4 is illustrated in FIG. 8. Like reference numerals are again used for like components. In this arrangement, the stator 4 is divided into a plurality of sub-sections 19 each defining a set (S1-9) of said stator teeth 9. In the present embodiment, the sub-sections 19 each consist of two (2) stator teeth 9. The sub-sections 19 are separated from each other to magnetically de-couple the sets (S1-9) of said stator teeth 9. The stator teeth 9 in each sub-sections 19 are arranged in a generally U-shaped configuration with the stator teeth 9 projecting radially inwardly. It will be understood that the sub-sections 19 are supported in a frame or housing (not shown) within the electric machine 1. The stator teeth 9 carry windings 11 having the first coil topology [T1] detailed above and illustrated in FIG. 3.

It will be understood that the configurations of the sub-sections 19 may be modified. The sub-sections 19 may each consist of more than two stator teeth 9. In certain embodiments the sub-sections 19 may each consist of an even number of stator teeth 9. The stator teeth 9 may be disposed in pairs which are magnetically de-coupled from each other by one or more flux barriers 18. For example, the sub-sections 19 may each consist of four (4) stator teeth 9 arranged in two pairs which are magnetically de-coupled from each other by one or more flux barrier 18; or six (6) stator teeth 9 arranged in three pairs which are magnetically de-coupled from each other by one or more flux barrier 18. One or more hollow cavity may be formed in each sub-section 19 to form an intermediate flux barrier 18.

It will appreciated that further changes can be made to the electric machine 1 described herein without departing from the scope of the present invention.

1. An electric machine for providing tractive force to propel a vehicle, the electric machine comprising:
a rotor having a plurality of rotor poles, the rotor poles each formed by one or more permanent magnets; and
a part-annular stator having a plurality of stator teeth, each tooth having a separate winding;
the stator comprising a plurality of sets of said stator teeth, each set comprising more than one stator tooth and the sets being magnetically de-coupled from each other;
wherein the windings on the stator teeth in each set are in different phases (A, B, C).

2. The electric machine as claimed in claim 1, wherein the electric machine is a three-phase electric machine and each set consists of a pair of said stator teeth.

3. The electric machine as claimed in claim 2, wherein the stator comprises eighteen stator teeth and a winding topology for said stator teeth is as follows:
−A−B+B+C−C−A+A+B−B−C+C+A−A−B+B+C−C−A.

4. The machine as claimed in claim 1, wherein the stator comprises a plurality of flux barriers to magnetically de-couple the sets from each other.

5. The electric machine as claimed in claim 4, wherein the flux barriers comprise one or more hollow cavity formed in the stator.

6. The electric machine as claimed in claim 5, wherein the flux barriers comprise two hollow cavities formed in the stator between each set of stator teeth.

7. The electric machine as claimed in claim 4, wherein the stator comprises a part-annular section from which the stator teeth extend radially inwardly, the flux barriers being formed in said part-annular section.

8. The electric machine as claimed in claim 7,
wherein the flux barriers are formed in the part-annular section between said stator teeth.

9. The electric machine as claimed in claim 1, wherein the stator comprises a plurality of sub-sections which are magnetically de-coupled from each other, at least one of said sets being formed in each sub-section.

10. The electric machine as claimed in claim 9, wherein said sub-sections each comprise one or more flux barrier.

11. An electric machine for providing tractive force to propel a vehicle, the electric machine comprising:
a rotor having a plurality of rotor poles, the rotor poles each formed by one or more permanent magnets; and
a stator having a plurality of stator teeth, each tooth having a winding;
the stator comprising a plurality of sets of said stator teeth, each set comprising more than one stator tooth;
wherein the stator comprises a plurality of flux barriers to magnetically de-couple the sets from each other.

12. The electric machine as claimed in claim 11, wherein the flux barriers comprise one or more hollow cavity formed in the stator.

13. The electric machine as claimed in claim 12, wherein the flux barriers comprise two hollow cavities formed in the stator between each set of stator teeth.

14. The electric machine as claimed in claim 11, wherein the stator comprises an outer section from which the stator teeth extend radially inwardly, the flux barriers being formed in said outer section.

15. The electric machine as claimed in claim 14, wherein said outer section is annular or part-annular.

16. The electric machine as claimed in claim 11, wherein the windings on the stator teeth in each of said sets is in a different phase (A, B, C).

17. The electric machine as claimed in claim 11, wherein the electric machine is a three-phase electric machine.

18. A vehicle comprising the electric machine as claimed in claim 1.

19-20. (canceled)
